(19) United States
(12) Patent Application Publication
(10) Pub. No.: US 2005/0146390 A1
(43) Pub. Date: Jul. 7, 2005

(54) Multi-layer substrate having impedance-matching hole

(76) Inventor: Jae-Myung Baek, Suwon-si (KR)

Correspondence Address: CHA & REITER, LLC, 210 ROUTE 4 EAST STE 103, PARAMUS, NJ, 07652, US

(21) Appl. No.: 10/813,952

(22) Filed: Mar. 31, 2004

(30) Foreign Application Priority Data
Jan. 7, 2004 (KR) 2004-841

(51) Int. Cl. H01P 5/02

(52) U.S. Cl. 333/33

(57) ABSTRACT

A multi-layer substrate comprising: a plurality of metal layers, on each of which a predetermined printed-circuit pattern is formed; and at least one insulating layer formed between the metal layers, wherein the plurality of metal layers includes: at least two high-frequency signal layers for transmitting a high-frequency signal. At least one ground layer provides a ground for the other metal layers, and wherein at least one via hole is formed through the multi-layer substrate to connect the high-frequency signal layers to each other. An impedance-matching hole passes through the ground layer so as to provide a path through which the via hole passes, and wherein a distance between the via hole and the ground layer is adapted for adjustment by the impedance-matching hole to adjust capacitance, so that a quasi waveguide is formed and impedances in part of the hole are matched when a high-frequency signal is transmitted through the hole. Ground pads which are electrically connected to the ground layer and signal pads which are connected to the hole to help the adjustment of capacitance and increase matched bandwidth.

### CLAIM OF PRIORITY

This application claims priority from an application entitled “Multi-layer substrate having impedance-matching hole,” filed in the Korean Intellectual Property Office on Jan. 7, 2004 and assigned Ser. No. 2004-841, the contents of which are hereby incorporated by reference.

### BACKGROUND OF THE INVENTION

1. Field of the Invention

The present invention relates to a multi-layer substrate. More particularly, the present invention relates to a multi-layer substrate in which impedance is matched in such a manner that an interval between a ground layer and a via hole is adjusted in the substrate.

2. Description of the Related Art

As current technology trends of various electronic devices, such as an information communication apparatus and the like, move toward smaller-size, lighter weight, and higher performance characteristics, the utilization of a multi-layer substrate becomes a necessary component for constituting an electrical system in such an electronic device. The multi-layer substrate includes a plurality of stacked metal layers on which printed circuit patterns are formed and insulating layers formed between the metal layers.

FIG. 1 is a sectional view illustrating a construction of a conventional multi-layer substrate 10 having a via hole 12. As shown in FIG. 1, the conventional multi-layer substrate 10 having the via hole 12 includes a plurality of metal layers 23, 25, 26, and 27 on which predetermined printed circuit patterns (not shown), respectively, and insulating layers 24 formed between the metal layers 23, 25, 26, and 27. When looking among the metal layers, those indicated by reference numbers 23 and 27 function to transmit high-frequency signals, one metal layer 26 is a ground layer for impedance matching of high-frequency signal lines, and the other metal layer 25 functions to transmit DC and a low-frequency signal. The metal layers 23 and 27 for high-frequency signals are electrically connected with each other through a via hole 12, by a vertical plated layer 18 for electrically connecting the metal layers 23 and 27 for high-frequency signals with each other is formed on an inside wall of the via hole 12.

Meanwhile, in order to reduce an impedance mismatching caused by an inductance component of the via hole 12, the multi-layer substrate 10 is fabricated so as to minimize the amount of inductance either by lengthening the diameter “d” of the via hole 12 or by shortening the length “L” of the via hole 12. Also, the multi-layer substrate can be used with another method that ground holes (not shown) extended so as to be in a line with the via hole 12 are formed around the via hole 12.

However, by adjusting the diameter and the length of the via hole for impedance matching in the multi-layer substrate, there are problems introduced in that interference may be caused according to the diameter of the via hole and the signal lines, such as a printed circuit pattern and the like, and also that the multi-layer substrate must ensure the minimum thickness of an insulating layer, so that it is difficult to reduce inductance by desired amount. Also, forming a separate ground hole in the vicinity of the via hole may increase the interference problem with signal lines, such as an adjacent printed-circuit pattern.

### SUMMARY OF THE INVENTION

Accordingly, the present invention has been made in part to solve some of the above-mentioned problems occurring in the prior art. An object of the present invention is to provide a multi-layer substrate that achieves impedance matching therein in transmitting a high-frequency signal using a via passage with an impedance matching hole.

To accomplish this object, in accordance with one aspect of the present invention, there is provided a multi-layer substrate comprising: a plurality of metal layers, on each of which a predetermined printed-circuit pattern is formed; and at least one insulating layer formed between the metal layers, wherein the plurality of metal layers includes: at least two high-frequency signal layers for transmitting a high-frequency signal; and at least one ground layer to provide a ground for other metal layers, and wherein at least one via hole is formed through the multi-layer substrate to connect the high-frequency signal layers to each other and an impedance-matching hole extends through the ground layer so as to provide a path through which the via hole passes, and wherein a distance between the via hole and the ground layer is adjusted by the impedance-matching hole to adjust capacitance, so that impedances of the multi-layer substrate are matched when a high-frequency signal is transmitted among the various layers.

### BRIEF DESCRIPTION OF THE DRAWINGS

The above aspects, features and advantages of the present invention will be more apparent from the following detailed description taken in conjunction with the accompanying drawings, in which:

FIG. 1 is a sectional view illustrating a construction of a conventional multi-layer substrate having a via;

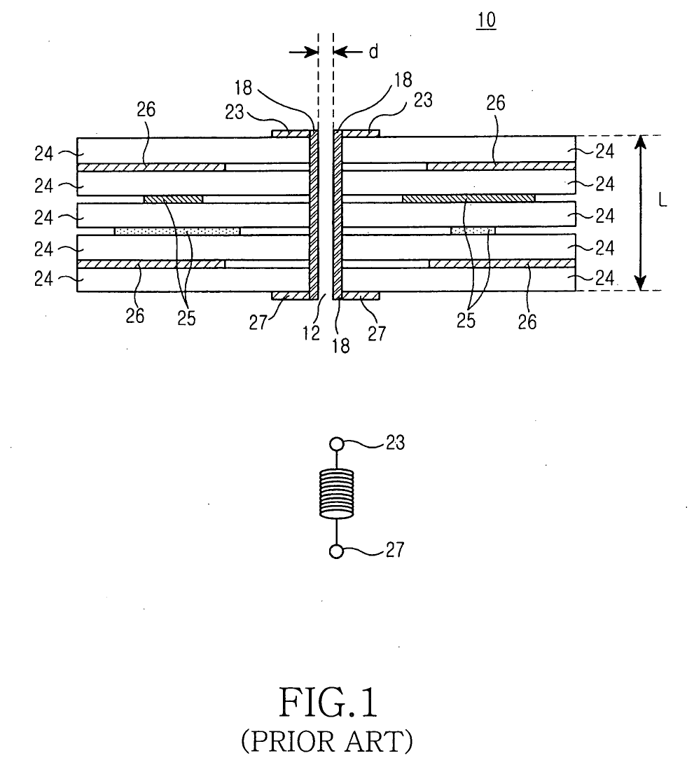

FIG. 2 is a sectional view illustrating a construction of a multi-layer substrate having an impedance-matching hole according to one preferred aspect of the present invention;

FIG. 3 is a sectional view of the multi-layer substrate, taken along line A-A′ in FIG. 2;

FIG. 4 is a sectional view of the multi-layer substrate, taken along line B-B′ in FIG. 2;

FIG. 5 is a construction view illustrating an electrical model of a waveguide for high frequencies; and

FIGS. 6A and 6B are graphs showing properties of a via hole and an impedance matching hole in multi-layer substrates having a thickness of 1 mm.

### DETAILED DESCRIPTION OF THE INVENTION

Hereinafter, one preferred aspect of a multi-layer substrate having an impedance-matching hole according to the present invention will be described with reference to the accompanying drawings. In the following description of the present invention, a detailed description of known functions and configurations incorporated herein will be omitted when it may make obscure the subject matter of the present invention.

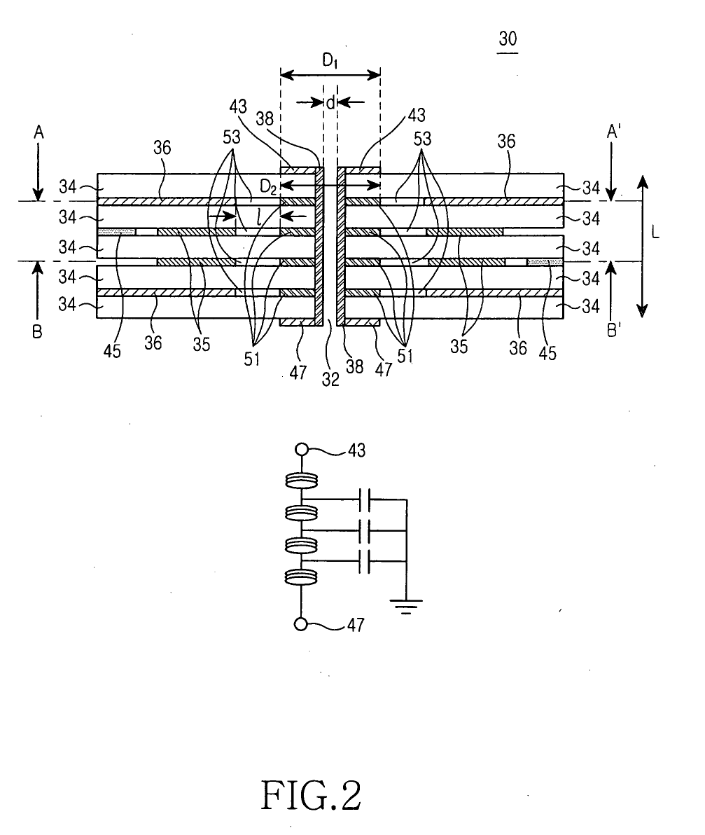

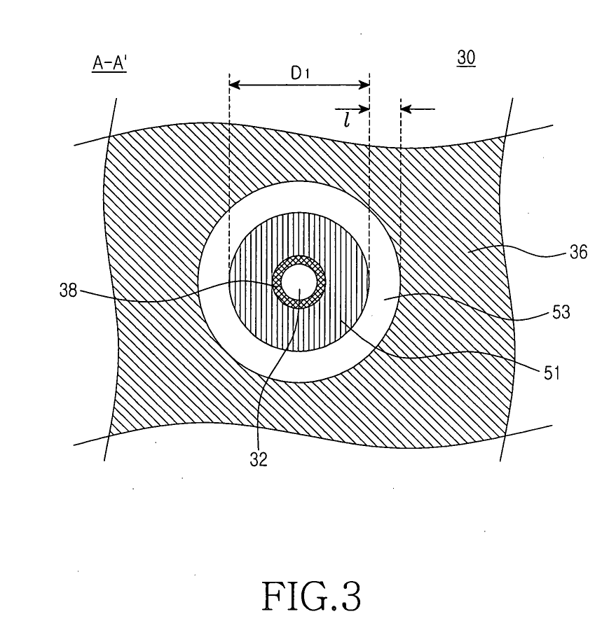

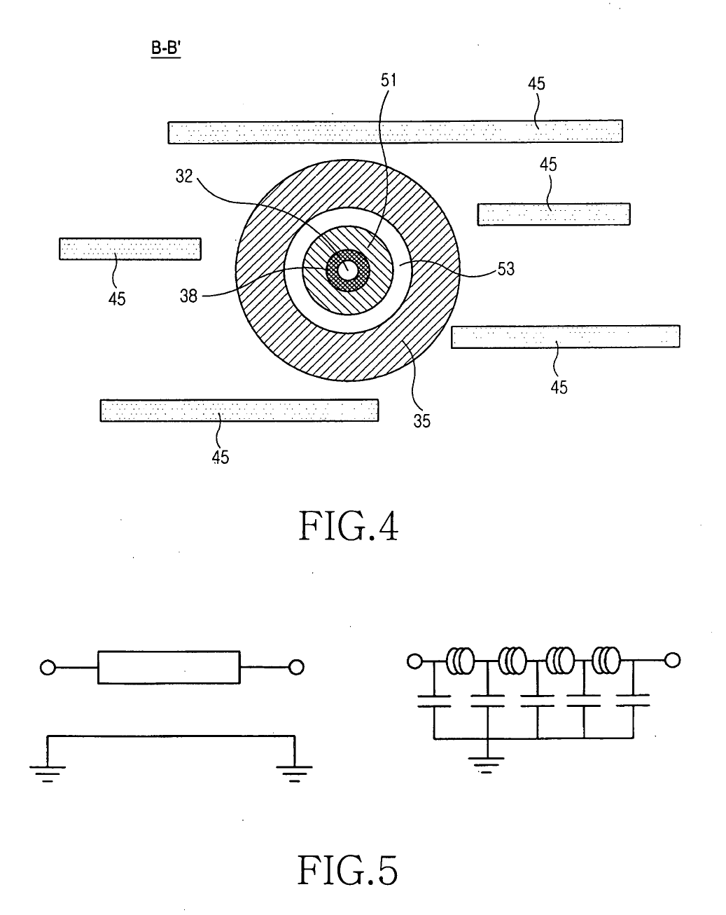

FIG. 2 is a sectional view illustrating a construction of a multi-layer substrate 30 having an impedance-matching hole according to one aspect of the present invention, FIG. 3 is a sectional view of the multi-layer substrate 30, taken along line A-A′ in FIG. 2, and FIG. 4 is a sectional view of the multi-layer substrate 30 taken along line B-B′ in FIG. 2. As shown in FIGS. 2 and 3, the multi-layer substrate 30 includes a hole 32 comprising metal layers 43 and 47 for high-frequency signals, a metal layer 45 for low-frequency signals and DC, a ground layer 36, insulating layers 34, the via hole 32, a ground pad 35, the impedance-matching hole 53, and a signal pad 51.

The metal layers 43, 45, 47, 35, 36, and 51 are formed as predetermined printed circuit patterns (not shown), respectively, and are stacked in the multi-layer substrate 30. Each of the metal layers 43, 45, 47, 35, 36, and 51 are configured in such a manner that the respective metal layers are stacked on the insulating layers 34, respectively. That is, the respective insulating layers 34 are formed so as to be interposed between respective metal layers 43, 45, 47, 35, 36, and 51. In addition, from among the metal layers 43, 45, 47, 35, 36, and 51, the ground layer 36 is arranged to provide a ground to the other metal layers, and at least one ground layer 36 is formed in the multi-layer substrate 30.

The via hole 32 may extend either through the multi-layer substrate 30 from one surface of the multi-layer substrate 30 or only to a predetermined length without passing through the entire multi-layer substrate 30. The metal layers 43 and 47 for high-frequency signals are electrically connected with each other through the via hole 32. In order to connect the metal layers 43 and 47 for high-frequency signals with each other, a plated layer 38 is formed on an inside wall of the via hole 32. The metal layers 43, 45, 47, 35, 36, and 51 and the plated layer 38 can be made from a material such as copper (Cu) or the like.

Meanwhile, in order to provide impedance matching in the multi-layer substrate 30, the multi-layer substrate 30 includes the matching hole 53 passing through the ground layer 36. The matching hole 53 provides a path through which the via hole 32 passes. The diameter (D₂+2 l) of the matching hole 53 is adjusted in order to maintain an appropriate distance between the via hole 32 and a ground pad 35 or a ground layer 36.

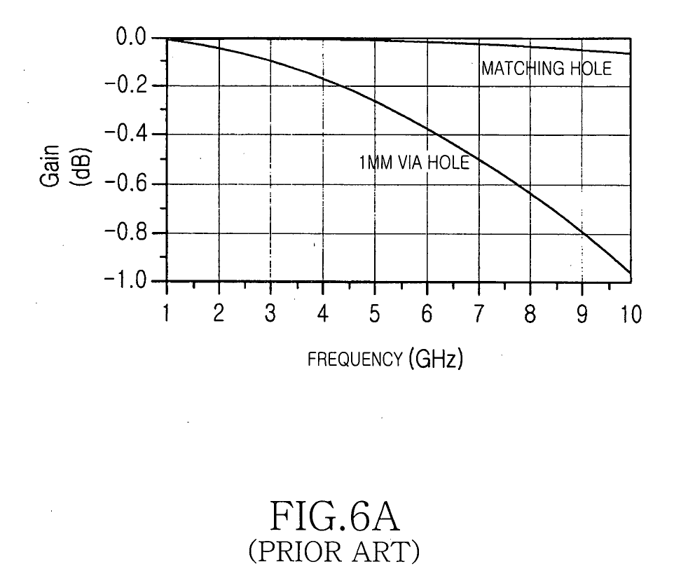

In other words, both the size of the matching hole 53 and the signal pad 51 are adjusted according to a dielectric constant and a thickness of the insulating layer 34, so that capacitance components between the via hole 32 and either the ground layer 36 or the ground pad 35 can be adjusted. The capacitance components are each connected between series-connected inductance components (see FIG. 2), thereby achieving impedance matching as in a high-frequency waveguide (see FIG. 5). Note that the smaller the physical size becomes, the higher the bandwidth is achieved.

The signal pad 51 is located inside of the matching hole 53 and has a ring shape that extends from the outer-circumference surface of the plated layer 38 to an exterior, leaving a gap between the signal pad 51 and the ground pad 35 or the ground layer 36. Also, the signal pad 51 is electrically connected with the plated layer 38. The signal pad 51, the ground layer 36, and the ground pad 35 are manufactured through a pattern fabricating process of a printed circuit board and generally has a very low work tolerance of 10 μm or less. Therefore, it is possible to manufacture a multi-layer substrate having the same gaps (l) between the signal pads 51 and respective corresponding ground factors 35 and 36 as designed, and is thus possible to achieve a desired capacitance.

In general, the ground pad 35 is connected with the ground layer 36 through a plurality of via holes. Sizes of the signal pad 51 and the ground pad 35 are adjusted according to a dielectric constant and a thickness of the insulating layer 34. If the via holes can be manufactured with a low work tolerance, the signal pad 51 can be omitted, and it is possible to obtain a designed capacitance by means of a distance between the via holes and the respective ground factors 35 and 36. When each layer forming the multi-layer substrate has a sufficiently small thickness, the signal pad 51 and the ground pad 35 may be formed at an interval of several layers. The ground pad 35 and the ground layer 36 may be formed on the metal layers 43 and 47 having signal lines.

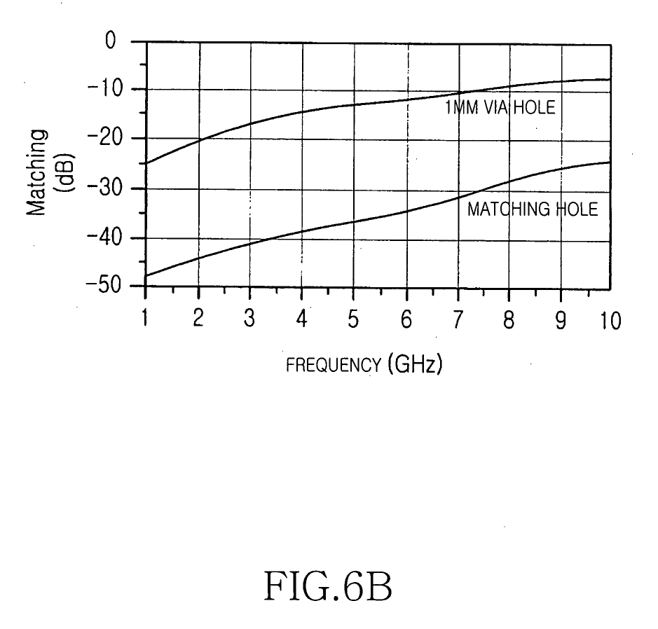

FIG. 6A shows gain characteristics and FIG. 6B shows matching characteristics in a multi-layer substrate having the total thickness of 1 mm, in comparison with a first case in which only a via hole having a diameter of 200 μm is formed (0.799 nH), in a second case in which impedance is matched by using the signal pad 51 and ground pad 35. Referring to the gain characteristics shown in FIG. 6A, it is shown that the convention multi-layer substrate has more loss as a frequency increases, while the multi-layer substrate according to this aspect of the present invent shows a relatively constant gain distribution regardless of a frequency band. Also, with the matching characteristics shown in FIG. 6B, it can be shown that the multi-layer substrate according to this aspect of the present invent shows a relatively better operation than known heretofore.

Meanwhile, the above-mentioned multi-layer substrate 30 has a form in which a plurality of unit substrates (not shown) are stacked and attached to each other. The substrates are attached to each other by using a prepreg, and the prepreg itself serves as a substrate after heat treatment. A Teflon-series substrate of the above-mentioned substrates has an excellent high-frequency characteristic. However, it is difficult to manufacture a Teflon-only prepreg because a heat treatment process with a higher temperature (˜220° C.) than that for normal substrates is required when the Teflon-only prepreg is connected to another layer. When a substrate is formed by attaching general Teflon-series layers with each other by means of a normal prepreg, adhesive strength is poor, so that the attached substrates may be separated. Particularly, if the substrates around the via hole are separated, the plating solution will connect the plated layer 38 to the ground factors 35 and 36, or the metal layer 45, for low-frequency signals and DC when the plated layer 38 is formed, causing a fault.

Since the signal pad 51 has been formed on a metal layer pre-attached on a Teflon-series substrate, it is possible to reduce an adhesive fault by attaching the prepreg on the signal pad, not the Teflon-series substrate. The signal pad can be formed not only for the high-frequency via, but also for another via hole for transmitting DC and low-frequency signals among other layers in order to increase adhesive strength.

As described above, according to the multi-layer substrate having an impedance-matching hole of the present invention, the capacitance of the via hole is adjustable by varying a distance between the ground factor and the via hole in the multi-layer substrate according to the inductance of the via hole and the dielectric constant and the thickness of the insulating layer, so that impedance matching can be achieved. Moreover, the distance adjustment between the ground and the via hole is performed by using the signal pad and the ground pad, so that the same capacitance as designed can be easily obtained. Also, when the signal pad is attached on the Teflon-series substrate, its adhesive strength is increased by using a normal prepreg having a low heat-treatment temperature, so that it is possible to improve the reliability of goods.

While the invention has been shown and described with reference to certain preferred embodiments thereof, it will be understood by those skilled in the art that various changes in form and details may be made therein without departing from the spirit and scope of the invention as defined by the appended claims.

1. A multi-layer substrate comprising:
a plurality of metal layers each having a predetermined printed-circuit pattern formed thereon; and
at least one insulating layer formed between each of the metal layers,
wherein the plurality of metal layers includes:
at least two high-frequency signal layers for transmitting a high-frequency signal; and
at least one ground layer to provide a ground for other metal layers, and
wherein at least one via hole is formed through the multi-layer substrate to connect the high-frequency signal layers to each other, and an impedance-matching hole passes through the ground layer so as to provide a path through which the via hole passes, and
wherein a distance between the via hole and the ground layer is adapted for adjustment by the impedance-matching hole to adjust capacitance from the via hole to ground and for making quasi waveguide with intrinsic inductance of the via hole, so that impedances of the multi-layer substrate are matched when a high-frequency signal is transmitted among the signal layers.

2. The multi-layer substrate as claimed in claim 1, further comprising a signal pad in the same metal layer with the ground layer which is electrically connected to an exterior wall of the via hole, said signal pad extends outside of the via hole.

3. The multi-layer substrate as claimed in claim 2, wherein the signal pad has a ring shape, and a capacitance between the ground layer and the via hole is adjusted according to an inductance of the via hole and the dielectric constant and the thickness of the insulating layer, so that a quasi waveguide is formed and impedances of the multi-layer substrate are matched.

4. The multi-layer substrate as claimed in claim 1, wherein ground pads are provided in all or some metal layers except ground layers, in which the ground pads are electrically connected with the ground layer through the via hole and serves as a ground.

5. The multi-layer substrate as claimed in claim 4, wherein the signal pads have ring shape and a reformed in all metal layers having the ground pad, and a capacitance between the ground pad and the signal pad is adjusted according to an inductance of the hole between continual ground pads or ground layer, a dielectric constant and a thickness of the insulating layer, so that a quasi waveguide is formed and impedances of the multi-layer substrate are matched.

6. The multi-layer substrate as claimed in claim 4, wherein a capacitance between the ground pad and the via hole is selectively adjusted according to an inductance of the via hole connected to the capacitance, a dielectric constant and a thickness of the insulating layer, so that a quasi waveguide is formed by the capacitance and the inductance, thus matching impedances of the multi-layer substrate.

7. A multi-layer substrate comprising:
a plurality of metal layers, on each of which a predetermined printed-circuit pattern is formed;
at least two insulating layer formed between the metal layers; and
at least one signal pad which is electrically connected to a via hole to increase an attaching force between layers of the substrate when a high-frequency signal, a low-frequency signal, or DC is transmitted from one layer to another layer through the via hole.

8. The multi-layer substrate according to claim 7, wherein at least one Teflon substrate further comprises the signal pad formed on metal layer pre-attached on a Teflon substrate to increase an attaching force between the Teflon layer and to prepreg which is used to attach substrates and become substrate after thermal treatment.
